(19) United States
(12) Patent Application Publication
(10) Pub. No.: US 2018/0257846 A1
(43) Pub. Date: Sep. 13, 2018

(54) BEVERAGE CONTAINER

(71) Applicant: Danhong Pan, Shanghai (CN)

(72) Inventor: Danhong Pan, Shanghai (CN)

(73) Assignee: Polyconcept North America, Inc., New Kensington, PA (US)

(21) Appl. No.: 15/455,222

(22) Filed: Mar. 10, 2017

(51) Int. Cl. B65D 81/38; A47J 41/00; A47G 23/02; B65D 43/02; B65D 47/06; B65D 43/20; B65D 51/18

(52) U.S. Cl. CPC B65D 81/3881; B65D 2543/0049; A47G 23/0266; A47G 23/0241; B65D 43/0229; B65D 47/06; B65D 43/20; B65D 51/18; A47G 2023/0275; B65D 2251/0018; B65D 2251/0028; B65D 2251/0081; B65D 2251/0087; B65D 2251/009; B65D 2543/00046; A47J 41/0072

(57) ABSTRACT

A double-walled insulated container including an outer member being formed of a metal material and comprising a substantially tubular sidewall having a first end to engage a first lid assembly and a second end comprising a recess to receive therein a second lid assembly, an inner member being formed of a metal material and including a substantially annular sidewall defining a receptacle having a first end and a second end, and a ledge formed in the sidewall between the first end and the second end and extending completely around and from the sidewall into the receptacle to define an upper portion of the receptacle to receive a beverage container supported by the ledge and a lower portion of the receptacle to receive a thermal transfer material, and an insulating member being formed of a metal material and disposed in an annular space defined between the sidewalls of the outer and inner members.

### BACKGROUND

This invention generally relates to containers for beverage containers and beverages.

Consumers of hot and cold beverages may suffer from the inconvenience of carrying two beverages containers, namely one for hot beverages and one for cold beverages. For example, consumers of hot beverages, e.g., coffee and tea, may use insulated beverage containers, such as a travel tumbler, that insulate the beverage retained therein from the ambient temperature to reduce cooling of the beverage. Consumers of cold beverages, generally from a can or a bottle, may use beverage container insulators, such as described in U.S. Pat. No. 4,293,015, that insulate the beverage container retained therein from the ambient temperature to reduce warming of the beverage container and beverage therein. In addition, conventional beverage container insulators may generally require the beverage container to be chilled beforehand. Accordingly, more efficient and/or cost-effective beverages containers that provide insulation and reduce heat transfer of beverages as well as other beverage containers retained therein may be desirable.

### SUMMARY

According to various aspects, more efficient and/or cost-effective beverage containers are described.

A double-walled insulated container including an outer member being formed of a metal material and comprising a substantially tubular sidewall having a first end to engage a first lid assembly and a second end comprising a recess to receive therein a second lid assembly, an inner member being formed of a metal material and including a substantially annular sidewall defining a receptacle having a first end and a second end, and a ledge formed in the sidewall between the first end and the second end and extending completely around and from the sidewall into the receptacle to define an upper portion of the receptacle to receive a beverage container supported by the ledge and a lower portion of the receptacle to receive a thermal transfer material, and an insulating member being formed of a metal material and disposed in an annular space defined between the sidewalls of the outer and inner members.

### DESCRIPTION OF THE DRAWINGS

The various embodiments described herein may be better understood by considering the following description in conjunction with the accompanying drawings.

FIG. 1 includes a top perspective view of a beverage container.

FIG. 2 includes a front view of the beverage container shown in FIG. 1.

FIG. 3 includes a rear view of the beverage container shown in FIG. 1.

FIG. 4 includes left side view of the beverage container shown in FIG. 1.

FIG. 5 includes a right side view of the beverage container shown in FIG. 1.

FIG. 6 includes a top view of the beverage container shown in FIG. 1.

FIG. 7 includes a bottom view of the beverage container shown in FIG. 1.

FIG. 8 includes a cross-section of the front view of the beverage container shown in FIG. 1.

FIG. 9 includes a cross-section of the beverage container shown in FIG. 1.

FIGS. 10A and 10B include cut-away views of the beverage container.

### DESCRIPTION

As generally used herein, the articles “one”, “a”, “an” and “the” refer to “at least one” or “one or more”, unless otherwise indicated.

As generally used herein, the terms “including” and “having” mean “comprising”.

Various aspects of the beverage container may be illustrated by describing components that are coupled, attached, and/or joined together. As used herein, the terms “coupled”, “attached”, and/or “joined” are interchangeably used to indicate either a direct connection between two components or, where appropriate, an indirect connection to one another through intervening or intermediate components. In contrast, when a component is referred to as being “directly coupled”, “directly attached”, and/or “directly joined” to another component, there are no intervening elements shown in said examples.

Various aspects of the beverage container and lid may be illustrated with reference to one or more exemplary implementations. As used herein, the term “exemplary” means “serving as an example, instance, or illustration,” and should not necessarily be construed as preferred or advantageous over other variations of the devices, systems, or methods disclosed herein. “Optional” or “optionally” means that the subsequently described event or circumstance may or may not occur, and that the description includes instances where the event occurs and instances where it does not.

Furthermore, throughout the specification, reference to “one embodiment,” “an embodiment,” or “some embodiments” means that a particular described feature, structure, or characteristic is included in at least one embodiment. Thus, appearances of the phrases “in one embodiment,” “in an embodiment,” or “in some embodiments” in various places throughout this specification are not necessarily all referring to the same embodiment. Those skilled in the art will recognize that the various embodiments detailed herein can be practiced without one or more of the specific details or with other methods, components, materials, etc. In other instances, well-known structures, materials, or operations are not shown or not described in detail to avoid obscuring aspects of the embodiments.

Relative terms such as “lower” or “bottom” and “upper” or “top” may be used herein to describe one element's relationship to another element illustrated in the drawings. It will be understood that relative terms are intended to encompass different orientations of aspects of the beverage container and lid in addition to the orientation depicted in the drawings. By way of example, if aspects of the lid shown in the drawings are turned over, elements described as being on the “bottom” side of the other elements would then be oriented on the “top” side of the other elements as shown in the relevant drawing. The term “bottom” can therefore encompass both an orientation of “bottom” and “top” depending on the particular orientation of the drawing.

In the following description, certain details are set forth in order to provide a better understanding of various aspects of a beverage container. However, one skilled in the art will understand that these aspects may be practiced without these details and/or in the absence of any details not described herein. In other instances, well-known structures, methods, and/or techniques associated with methods of practicing the various aspects may not be shown or described in detail to avoid unnecessarily obscuring descriptions of other details of the various aspects.

According to various aspects, more efficient and/or cost-effective beverage containers and methods of making and using the same are described.

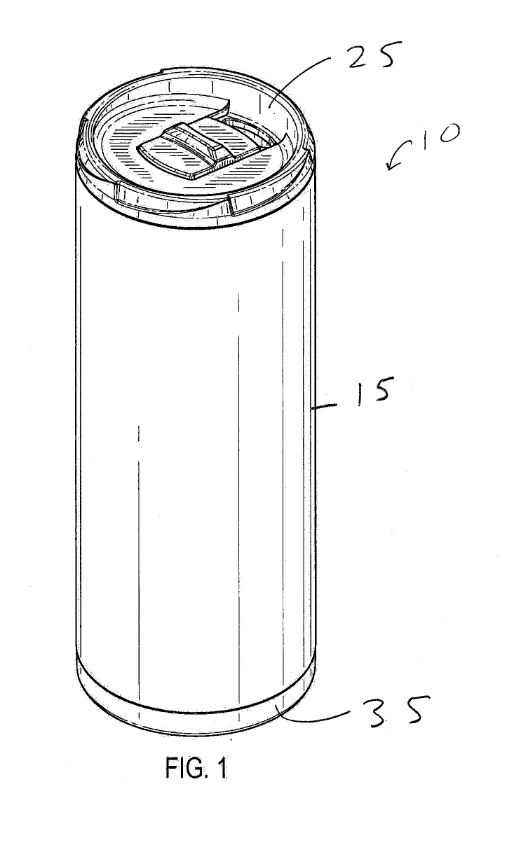

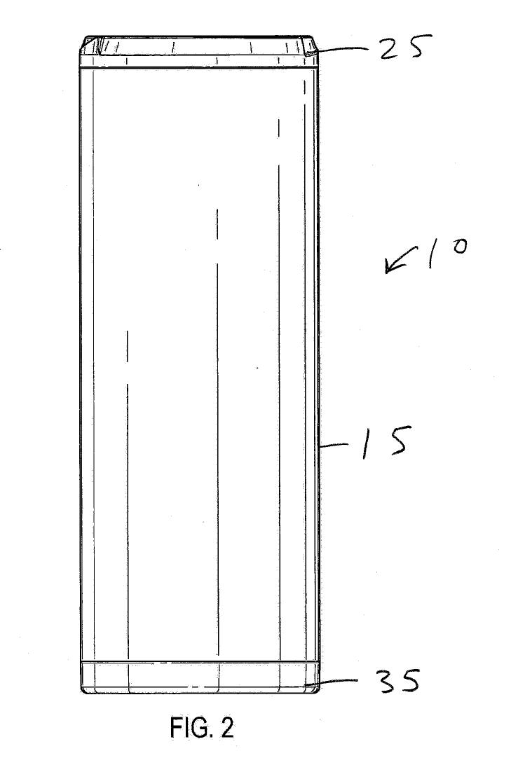

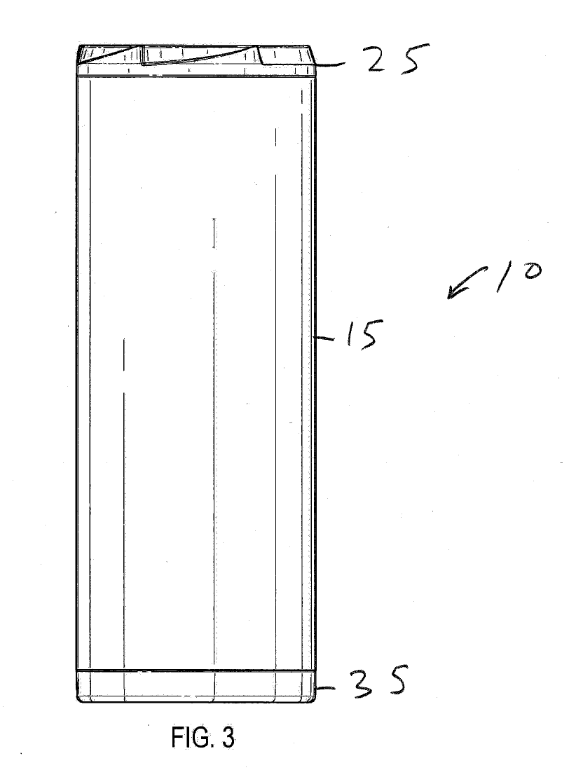

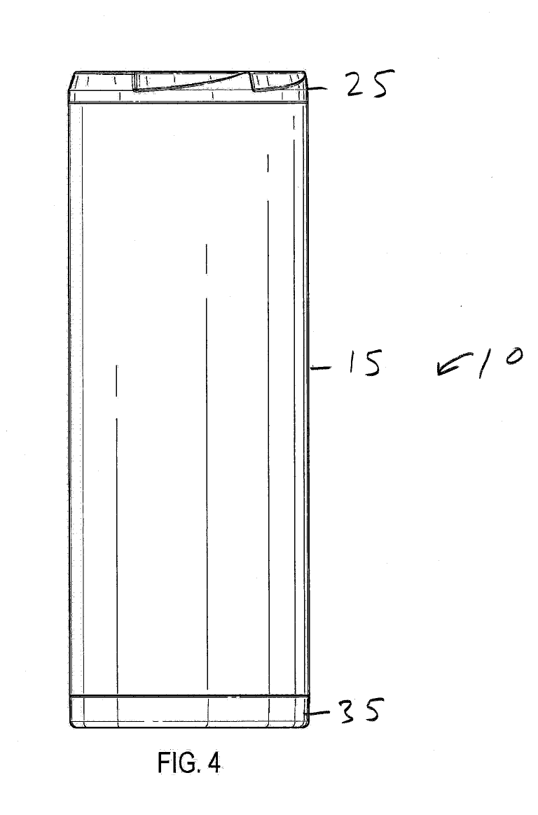

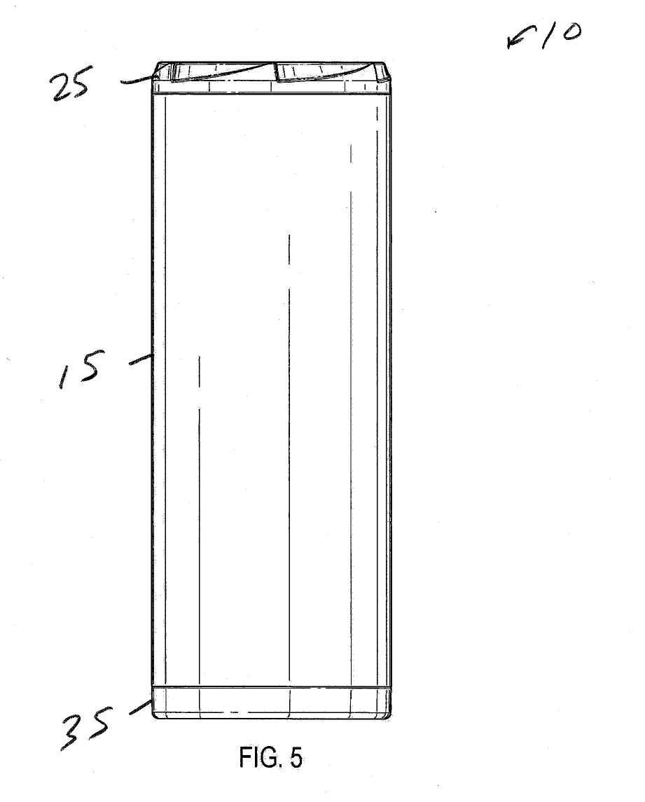

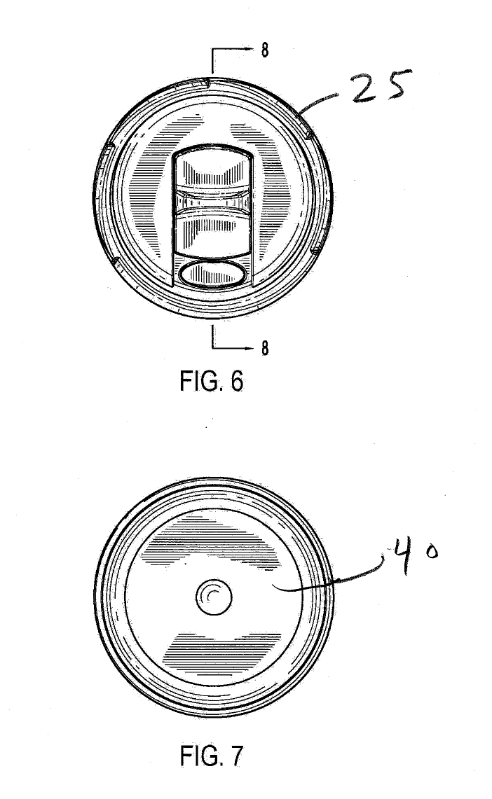

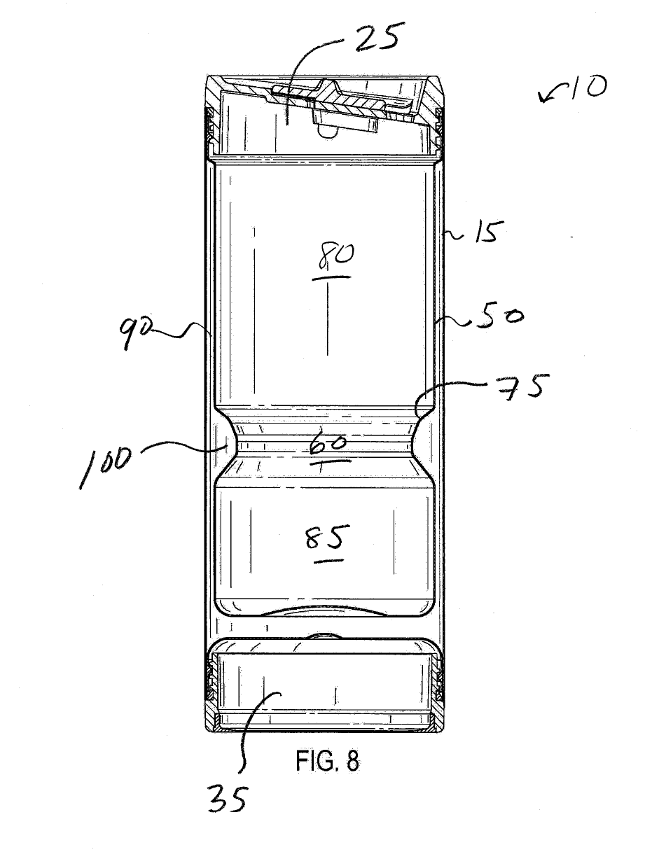

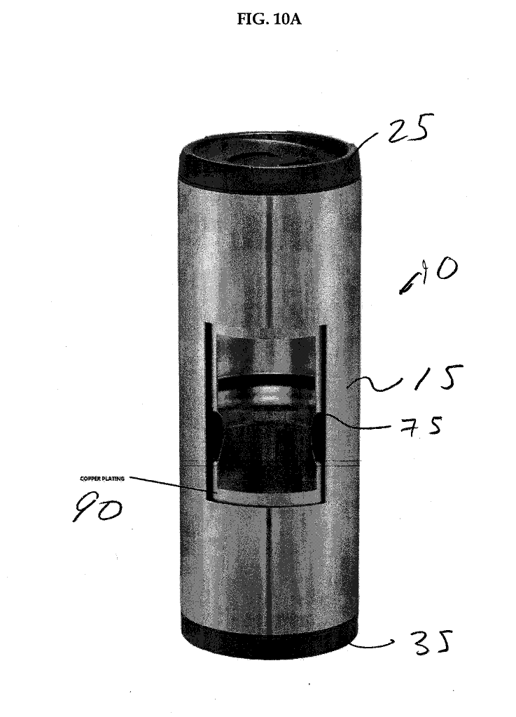

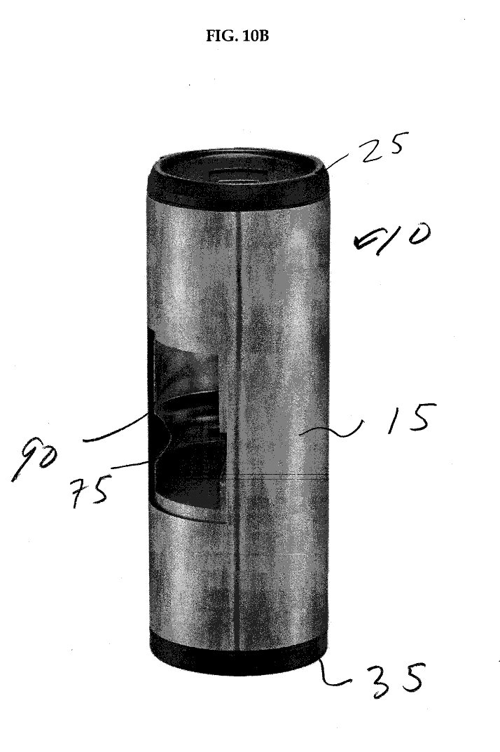

Referring to FIGS. 1-10, a double-walled insulated container 10 may generally comprise an outer member 15 being formed of a metal material and comprising a substantially tubular sidewall having a first end 20 to engage a first lid assembly 25 and a second end 30 comprising a recess 40 to receive therein a second lid assembly 35, an inner member 50 disposed within the outer member 15 and being formed of a metal material and comprising a substantially annular sidewall defining a receptacle 60 having a first end 65 and a second end 70, and a ledge 75 formed in the sidewall between the first end 65 and the second end 70 and extending completely around and from the sidewall into the receptacle 60 to define an upper portion 80 of the receptacle 60 to receive a beverage container supported by the ledge 75 and a lower portion 85 of the receptacle 60 to receive and hold a thermal transfer material (not shown), and an insulating member 90 being formed of a metal material and disposed in an annular space 100 defined between the sidewalls of the outer member 15 and inner member 50. The annular space 100 may be under some vacuum to thermally insulate the inner member 50 from the ambient atmosphere.

The thermal transfer material may comprise one of a thermally heating material and a thermally cooling material. The thermally cooling material may comprise ice and/or water. Ice may comprise ice particles, such as cubed ice, diced ice, chopped ice, or crushed ice.

The thermally heating material may comprise any composition capable of providing heat. For example, the thermally heating material may comprise a particulate mix of chemical compounds that undergo an oxidation reaction during use. The mix of compounds may comprise iron powder, activated carbon, a metal salt(s), and water. Mixtures of this type, which react when exposed to oxygen, providing heat for several hours. The metal salts may include sulfates, chlorides, carbonates, acetates, nitrates, and nitrites, such as sodium chloride, cupric chloride, and mixtures thereof.

The metal material comprising each of the outer member and inner member may comprise aluminum, stainless steel, and other metals. The material of the outer member and inner member may be the same or different.

The container may comprise four faces having a substantially square cross section having rounded, chamfered corners, although other geometric shapes are possible. For example, the container may be substantially round, including oval, triangular having three faces, rectangular, including square, with four faces, or may be any other geometric shape having four or more faces. The containers may comprise a combination of shapes, for example, a container including opposed flat panels between rounded panels.

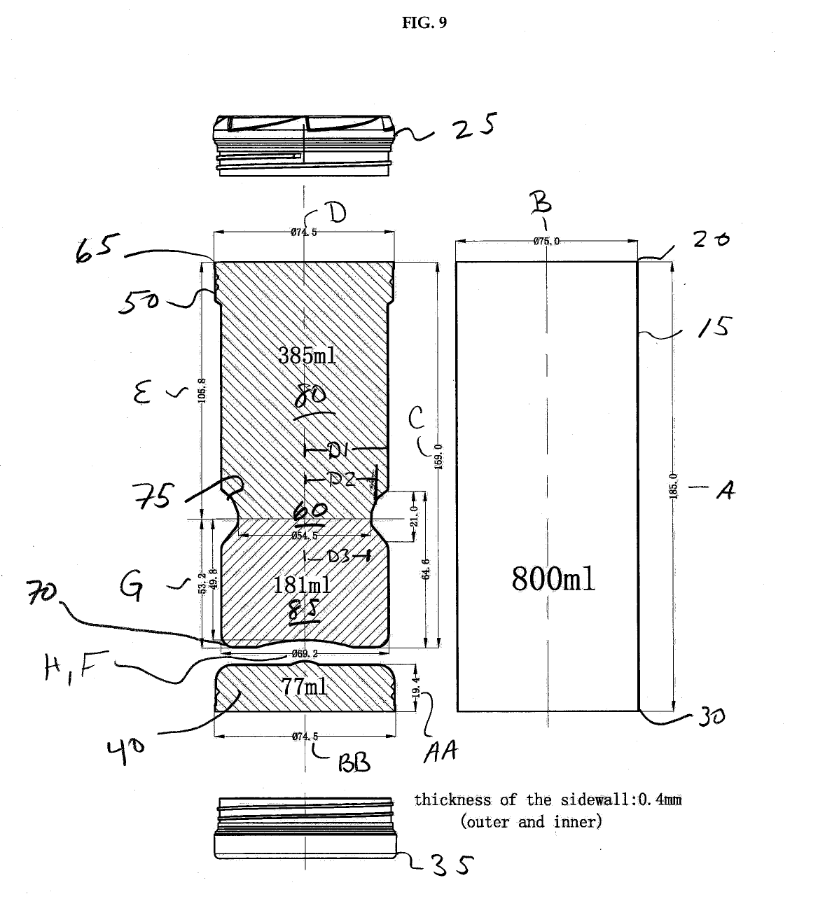

The container, including each of the inner member and outer member, may be cylindrical or any shape to receive a desired beverage container. Each of the upper portion of the receptacle and lower portion of the receptacle may have a substantially rectangular cross section or a substantially circular cross section. As shown in FIG. 8, for example, each of the upper portion of the receptacle and lower portion of the receptacle may have a substantially rectangular cross section. A distance from a central axis of the container to the sidewall of the upper portion of the receptacle may be the same or different as a distance from the central axis of the container to the sidewall of the lower portion of the receptacle. As shown in FIG. 8, for example, the distance from a central axis of the container to the sidewall of the upper portion of the receptacle may be the same as a distance from the central axis of the container to the sidewall of the lower portion of the receptacle.

The size and shape of the container, including the receptacle, may be sized and shaped to securely retain a beverage container, such as a can or bottle, in the upper portion of the receptacle and in direct contact with the thermal transfer material retained in the lower portion of the receptacle when the first lid assembly is coupled to the container. The size and shape of the container, including the receptacle, may be sized and shaped to receive and hold any type of liquid, e.g., cold water or soda, hot tea or coffee, etc., to maintain its temperature when the second lid assembly is coupled to the container. The container may comprise a height A of 90-370 mm, excluding the lid, a width B of 35-150 mm, and a volume of 400-1600 mL. The receptacle may comprise a height C of 80-320 mm and a width D of 35-150 mm. The upper portion of the receptacle may comprise a height E of 55-210 mm and a width F of 35-140 mm and a volume of 190-800 mL. The lower portion of the receptacle may comprise a height G of 25-100 mm and a width H of 35-140 mm and a volume of 90-360 mL. The volume of the upper portion of the receptacle may be greater than or equal to a volume of the lower portion of the receptacle. The ratio of the volume of the upper portion of the receptacle to the volume of the lower portion of the receptacle may be at least 1:1, such as 1:1-4:1, 2:1 to 3:1, 2:1, 2.1:1, and 2.25:1 provide improved/efficient thermal transfer material to heat/cool the beverage. The heating/cooling of the beverage may not be improved when the ratio is greater than 4:1. The volume of the upper portion of the receptacle may be equal to or greater than 170-1200 mL, such as 4 oz, 8 oz, 12 oz, 16 oz, 20 oz, and 24 oz. The distance between the sidewall of the inner member to an exterior surface of the beverage container may comprise up to 5 mm, such as 0.1-5 mm and 0.1-0.5 mm. The volume of the lower portion of the receptacle may be greater than or equal to a volume of the recess. The recess may comprise a height AA of 10-40 mm and a width BB of 25-150 mm and a volume of 35-140 mL. The container may be designed to fit into conventional cup-holders.

For example, the container may comprise a height A of 185 mm, excluding the lid, a width B of 75 mm, and a volume of 800 mL. The receptacle may comprise a height C of 159 mm and a width D of 74.5 mm, in which the upper portion of the receptacle may comprise a height E of 105.8 mm and a width F of 69.2 mm and a volume of 385 mL, and the lower portion of the receptacle may comprise a height G of 53.2 mm and a width H of 69.2 mm and a volume of 181 mL, and the recess may comprise a height AA of 19.4 mm and a width BB of 74.5 mm and a volume of 77 mL. The distance between the sidewall of the inner member to an exterior surface of the beverage container may be 0.4 mm.

The beverage container may reside substantially inside the upper portion of the receptacle when the beverage container is received therein and the thermal transfer material is received in the lower portion of the receptacle. The upper portion of the receptacle may have a height of up to substantially the same as the beverage container's height when the beverage container comprises a can. The height of the upper portion of the receptacle may be at least 50%, 75%, or 90% of the height of the beverage container when the beverage container comprises a can. The upper portion of the receptacle may have a height of less than the beverage container's height when the beverage container comprises a bottle. The height of the upper portion of the receptacle may be up to 50% of the height of the beverage container when the beverage container comprises a bottle. The beverage container may not reside in the lower portion of the receptacle.

The lower portion of the receptacle may retain the thermal transfer material in thermal communication with the beverage container and hold a sufficient amount of the thermal transfer material to reduce warming or cooling of the beverage as desired by the consumer. For example, the lower portion of the receptacle may hold ice particles, such as cubed ice, diced ice, chopped ice, or crushed ice in direct contact with a beverage container retained in the upper portion of the receptacle. Thermal transfer material in the lower receptacle may directly contact at least a portion of the beverage container when the beverage container is received in the upper portion of the receptacle. The thermal transfer material may directly and/or indirectly contact the bottom and/or side of the beverage container. The thermal transfer material may be maintained in direct contact with the beverage container to reduce warming or cooling of the beverage container without diluting or introducing contaminants into the beverage. The thermal transfer material also warm or cool the air in the lower portion of the receptacle to reduce warming or cooling of the beverage container. The beverage may be poured, served, and/or consumed from the beverage container without having to remove the beverage container from the container.

The second end of the sidewall of the inner member may comprise a closed end having an indentation to evenly distribute the thermal transfer material in the lower portion of the receptacle. A distance from a central axis of the container to the sidewall of the lower portion of the receptacle may be the greater than a distance from the central axis of the container to an end of the indentation.

The inner member and outer member may be joined in an integral manner by being welded together to form a unitary double walled container having the annular space located between the sidewalls of the inner and outer members. The outer member may comprise a generally cylindrical sidewall, and a generally concave bottom wall having a central depression. The inner member may comprise a generally cylindrical sidewall and a slightly concave bottom wall. The annular space may be under some vacuum to thermally insulate the inner member from the ambient atmosphere. The insulating space may comprise air or other gas.

The insulating member may comprise a substantially tubular sidewall having a first end and a second end. The first end may be open and the second end may be closed. The metal material comprising the insulating member may comprise a heat conducting material including copper or aluminum. For example the insulating member may comprise copper plating on an outer sidewall of the inner member or aluminum foil. The insulating member may improve the vacuum performance of the container to reduce warming or cooling of the beverage as desired by the consumer. For example, the insulating member may conduct heat from the beverage container or from the surrounding environment to the ice to thereby cool the beverage container or prevent or reduce ambient heat from reaching the beverage container. The air in the annular space may also provide thermal insulation properties. The insulating member and air in the annular space may work together to effectively maintain the beverage container at a cooler temperature insulated from the ambient environment.

The container may comprise at least one ledge therein to provide vertical and/or lateral support to the beverage container. When the lid assembly is securely coupled to the container, the beverage container may be held in substantial compression between the sealing member and the ledge. The ledge may be designed to self-center the beverage container within the container and maintain the beverage container in a substantially fixed position therein above the floor of the receptacle. The ledge may be designed to substantially maximize the surface area contact between the thermal transfer material and beverage container while supporting the beverage container.

The ledge may project inward from the sidewall of the inner member to the receptacle a sufficient distance to support a beverage container when such a beverage container is placed within the receptacle. The ledge may elevate the beverage container above the floor of the inner member to create sufficient space in the lower portion of the receptacle to retain and hold the thermal transfer material.

The ledge may comprise a height up to 50 mm, such as 15-30 mm, and a width up to 100 mm, such as 25-75 mm, as measured from the sidewall of the inner member. For example, the ledge may comprise a height of 21 mm and a width of 54.5 mm as measured from the sidewall of the inner member. The upper portion of the ledge upon which a beverage container may rest may be 30-120 mm above the bottom of the lower portion of the receptacle. The middle portion of the ledge may be 25-75 mm above the bottom of the lower portion of the receptacle. The lower portion of the ledge may be 20-60 mm above the bottom of the lower portion of the receptacle. For example, the upper portion of the ledge upon which a beverage container may rest may be 64.6 mm above the bottom of the lower portion of the receptacle, the middle portion of the ledge may be 49.8 mm above the bottom of the lower portion of the receptacle, and the lower portion of the ledge may be 43.6 mm above the bottom of the lower portion of the receptacle.

The ledge may comprise a curved cross section with respect to the receptacle. The ledge may comprise a curved inner wall including an upper portion and a lower portion. The slope of the curved inner wall may change its direction of curvature. The upper portion may slope away from the sidewall of the inner member and the lower portion may slope toward the sidewall of the inner member. The slopes of the upper portion and lower portion may be the same or different. The slope of the upper portion may be less than the slope of the lower portion. The inner wall may comprise a middle portion between the upper portion and lower portion. The middle portion may be substantially parallel to the sidewall of the inner member.

The structure of the ledge may be designed to support the exterior wall of the beverage container. The radius of curvature of the upper portion and/or middle portion may be designed to engage and support a beverage container when such a beverage container is placed within the receptacle. The ledge may be concave in shape with respect to the interior of the container. The base of the beverage container may comprise a convex annular exterior wall, such as a can or bottle. The concavity of the upper portion of the ledge may be designed to substantially mate to the convex annular exterior wall of the beverage container. The curvature of the lower portion of the ledge may be designed to retain the thermal transfer material in the lower portion of the receptacle. A skilled artisan may appreciate that the contours of the upper, middle, and/or lower portion of the ledge are not limited to this particular configuration, but may be straight or have a different curvature for beverage containers having other shapes.

The lower portion of the ledge may be curved, sloped and/or angled to reduce and/or prevent the thermal transfer material from moving up the sidewall of the inner member when the beverage container is tilted with respect to a central axis of the container. The container may be designed such that the thermal transfer material may contact the bottom wall of the beverage container but none of the thermal transfer material contacts a sidewall of the beverage container. The transfer material may move up the sidewall of the inner member through the aperture when the beverage container is tilted with respect to a central axis of the container. The thermal transfer material may contact the bottom wall and side walls of the beverage container.

When a beverage container is placed within the receptacle, a distance D1 from a central axis of the container to an outer periphery of the beverage container may be greater than or equal to a distance D2 from the central axis of the container to the periphery of the upper portion of the ledge. The distance D2 may be sufficiently wide such that the beverage container, when inside the receptacle, may not become wedged or stuck. For example, the largest exterior dimension of the beverage container may be less than the smallest interior dimension in the upper portion of the receptacle. When a beverage container is placed within the receptacle, the distance D1 may be equal to a distance D3 from the central axis of the container to the periphery of the middle portion of the ledge. The distance D3 may be sufficiently narrow such that the beverage container becomes removeably wedged or stuck when inside the receptacle. For example, the distance D3 of the middle portion of the ledge may be designed to approximately match the distance D1 of the beverage container to support the beverage container when such a beverage container is placed within the receptacle. The exterior and interior dimensions of the beverage container referred to above may be, for example, the distance between faces of a square design or diameter of a substantially circular design.

The second end of the outer member may comprise a bottom wall and a skirt including a downwardly extending exterior portion to define the recess. The bottom wall may by substantially horizontally oriented and have a peripheral edge joined to the skirt. The bottom wall may be substantially flat, slightly domed or even slightly concave. The skirt may extend downward from a peripheral edge at an angle generally parallel to the sidewall. The skirt may include an inner surface and an outer surface. The inner surface of the skirt may comprise a channel to engage and secure the lid assemblies in the recess.

The first lid assembly and/or second lid assembly may be removably coupled to the first end of the outer member and the other of the first lid assembly and second lid assembly may be removably coupled to the second end of the outer member, e.g, the recess. The lid assemblies may comprise threads along an external diameter thereof for engaging threads along an internal diameter of the outer member. The threads may be continuous or broken. The lid assemblies may be connected to the outer member, i.e., the opening and recess, and tightened and substantially sealed thereby. Each of the lid assemblies may comprise a plastic material, which may be the same or different.

Each of the lid assemblies may comprise a sealing member secured to the inside thereof and extended around the opening that may be sealed against the outer member. The sealing member may comprise a resilient material to apply pressure against the beverage container to create a liquid-tight seal. The sealing member may be secured to the lid assembly by adhesives, fusing, or bonding. The sealing member may comprise a resilient material, such as rubber, silicon, polypropylene, polyethylene, or a combination thereof, or other like materials.

The first lid assembly may comprise an opening to receive therethrough a portion of the beverage container when the beverage container is retained in the receptacle. The opening may comprise a central opening through which a neck of a can or bottle may extend. The first lid assembly may comprise a first sealing member extended on the inside and substantially around the central opening and a second sealing member extended on the outside and substantially around a portion of the exterior diameter thereof. The first sealing member may sealingly engage the beverage container to create a first liquid-tight seal around the portion of the beverage container extending through the central opening and the second sealing member may sealingly engage the outer member to create a second liquid-tight seal between the container and first lid assembly at substantially the same time. The first lid assembly may be tightened and thereby substantially seal the receptacle to prevent and/or reduce the thermal transfer material from leaking out of the receptacle when the beverage is consumed by a user. For example, the first lid assembly may be tightened and secured onto the container, with a neck extended through the central opening, the sealing member may engage and press against a portion of the beverage container, e.g., a shoulder of a can or bottle, to substantially seal the beverage container inside the receptacle. The lower portion of the receptacle may be substantially sealed by the beverage container when the first lid assembly is engaged with to the first end of the outer member.

The first lid assembly may retain the beverage container in a relatively fixed position inside the receptacle such that when the first lid assembly and container are tightened together, the beverage container may be held in substantial compression between the ledge and the sealing member pressed tightly against a shoulder of the beverage container to form a substantially liquid-tight seal. The container and first lid assembly may be designed to retain a beverage container having a certain height and diameter such that the shape, size, and location of the ledge and with the shape, size and location of sealing member substantially maintain the beverage container in a fixed position inside the receptacle. When the beverage container is held in this manner, the threaded connection between first lid assembly and beverage container may be sealed at the same time that the engagement between the sealing member and beverage container is sealed.

The beverage container may freely rotate along the ledge when the first lid assembly is sealingly coupled to the container and beverage container. That is, the compression of the beverage container between the ledge and sealing member may be sufficient to retain the beverage container in the receptacle while allowing the beverage container to rotate. This enables user to rotate the portion of the bottom wall of the beverage container that is in contact with the ice to improve the cooling of the beverage container.

The second lid assembly may comprise a sliding cap, a liquid through-hole, and a vent. The sliding cap may be slide between an open position and a closed position. When the liquid through-hole is opened and the sliding cap is in an open position, a drinking aperture may be formed by the inner surface of the container and the liquid through-hole such that a user may drink a beverage with which the receptacle is filled.

In use, ice particles may be placed in the lower portion of the receptacle before the beverage container is inserted. An indicator, such as the ledge, for example, or other indicator, may be provided on the inner wall of the inner member to indicate a maximum amount of ice that may be contained therein when the beverage container is inserted and properly positioned inside the receptacle. This may help the user appreciate the amount of the ice needed to maximize contact between the ice and the beverage container while avoiding too much ice that may prevent and/or inhibit the beverage container from being inserted into the receptacle and the first lid assembly from being sealingly tightened. Next, the beverage container may be inserted into the upper portion of the receptacle to rest on the ledge. The first lid assembly may be placed over the beverage container having the neck extend through the central opening, and then tightened onto the container. Tightening the first lid assembly may cause the sealing member to be pressed and sealed against the neck of the beverage container, while at the same time, the connection between the first lid assembly and container may also be sealed. This may trap the ice inside the lower portion of the receptacle to keep the beverage container therein cool. This may inhibit and/or prevent water, such as from melting ice, from leaking from the connection between the first lid assembly and the neck of the beverage container and the first lid assembly and container to allow the beverage to be poured and consumed directly from beverage container without having to remove beverage container from the ice. The first lid assembly may be placed in the recess and then tightened onto the container.

When the temperature of the beverage container is greater than that of the container, then heat from the beverage container may radiate to the insulating material, e.g., the copper plating, and be conducted downwardly to the ice. Similarly, ambient heat may be intercepted by the insulating material and likewise conducted downwardly to the ice. In addition, the thermal material, e.g., ice particles, may contact the bottom of the beverage container and/or cool the air in the lower portion of the receptacle to cool the beverage container.

While particular embodiments of beverage container have been illustrated and described, it would be obvious to those skilled in the art that various other changes and modifications can be made without departing from the spirit and scope of the invention. Those skilled in the art will recognize, or be able to ascertain using no more than routine experimentation, numerous equivalents to the specific devices, systems, and methods described herein, including alternatives, variants, additions, deletions, modifications and substitutions. This application including the appended claims is therefore intended to cover all such changes and modifications that are within the scope of this application.

What is claimed is:

1. A double-walled insulated container comprising:
an outer member being formed of a metal material and comprising a substantially tubular sidewall having a first end to engage a first lid assembly and a second end comprising a recess to receive therein a second lid assembly;
an inner member being formed of a metal material and comprising
a substantially annular sidewall defining a receptacle having a first end and a second end, and
a ledge formed in the sidewall between the first end and the second end and extending completely around and from the sidewall into the receptacle to define an upper portion of the receptacle to receive a beverage container supported by the ledge and a lower portion of the receptacle to receive a thermal transfer material; and
an insulating membex being formed of a metal material and disposed in an annular space defined between the sidewalls of the outer and inner members,
wherein the first lid assembly comprises an opening to receive therethrough a portion of the beverage container when the beverage container is retained in the receptacle, and
wherein the second lid assembly comprises a sliding cap and a liquid through-hole.

2. The container of claim 1, wherein the thermal transfer material comprises one of a thermally heating material and a thermally cooling material including ice and/or water.

3. The container of claim 1, wherein the beverage container resides substantially inside the upper portion of the receptacle when the beverage container is received therein.

4. The container of claim 3, wherein the upper portion of the receptacle has a height of up to substantially the same as the beverage container's height.

5. The container of claim 1, wherein the thermal transfer material directly contacts the beverage container when the beverage container is received in the upper portion of the receptacle.

6. The container of claim 1, wherein the beverage container does not reside in the lower portion of the receptacle.

7. The container of claim 1, wherein a distance from a central axis of the container to the sidewall of the upper portion of the receptacle is the same as a distance from the central axis of the container to the sidewall of the lower portion of the receptacle.

8. The container of claim 1, wherein a volume of the upper portion of the receptacle is greater than or equal to a volume of the lower portion of the receptacle, such as greater than 12 oz.

9. The container of claim 1, wherein a volume of the lower portion of the receptacle is greater than or equal to a volume of the recess.

10. The container of claim 1, wherein each of the upper portion of the receptacle and lower portion of the receptacle have a substantially rectangular cross section.

11. The container of claim 1, wherein the ledge has a curved cross section with respect to the receptacle.

12. The container of claim 1, wherein the first lid assembly comprises a first sealing member to sealingly engage the first end of the outer member and a second sealing member to sealingly engage a portion of the beverage container and retain the beverage container in the upper portion of the receptacle.

13. The container of claim 12, wherein the ledge engages a portion of the beverage container in a mamber that the beverage container is freely rotatable inside the upper portion of the receptacle.

14. The container of claim 12, wherein the lower portion of the receptacle is substantially sealed by the beverage container when the first lid assembly is engaged with to the first end of the outer member.

15. The container of claim 1, wherein the second end of the annular sidewall comprises a closed end having an indentation to evenly distribute the thermal transfer material in the lower portion of the receptacle.

16. The container of claim 15, wherein a distance from a central axis of the container to the sidewall of the lower portion of the receptacle is the greater than a distance from the central axis of the container to an end of the indentation.

17. The container of claim 1, wherein one of the first lid assembly and second lid assembly is removably coupled to the first end of the outer member and the other of the first lid assembly and second lid assembly is removably coupled to the second end of the outer member.

18. The container of claim 1, wherein the metal material of the insulating member comprises copper.

19. The container of claim 1, wherein the insulating member comprises a substantially tubular sidewall having an open first end and a closed second end.

20. The container of claim 1, wherein a ratio of a volume of the upper portion of the receptacle to a volume of the lower portion of the receptacle is 2.1:1.
